(19) United States
(12) Patent Application Publication
(10) Pub. No.: US 2018/0192686 A1
(43) Pub. Date: Jul. 12, 2018

(54) 3-DIMENSIONAL PRINTING OF FOOD

(71) Applicant: Yissum Research Development Company of the Hebrew University of Jerusalem Ltd., Jerusalem (IL)

(72) Inventors: Oded SHOSEYOV, Carmei Yosef (IL); Ido BRASLAVSKY, Ness Ziona (IL); Victor YASHUNSKY, Alon-Shvut (IL); Sigal BARUCH SHARON, Ness-Ziona (IL)

(73) Assignee: Yissum Research Development Company of the Hebrew University of Jerusalem Ltd., Jerusalem (IL)

(21) Appl. No.: 15/742,712

(22) PCT Filed: Jul. 7, 2016
(86) PCT No.: PCT/IL2016/050731

§ 371 Date: Jan. 8, 2018

Related U.S. Application Data
(60) Provisional application No. 62/190,344, filed on Jul. 9, 2015.

(51) Int. Cl. A23P 30/25; A21C 11/16

(52) U.S. Cl. CPC A23P 30/25; A23L 33/24; A21C 11/163

(57) ABSTRACT

Provided is a process and system for the production of a nutritional low-caloric food product, and food products produced thereby.

### TECHNOLOGICAL FIELD

The invention generally concerns printing of food products.

### BACKGROUND OF THE INVENTION

The food and beverage industry represents a multitrillion dollar business. The importance of this industry is clear and grows with the ever increasing global population. Subsequently, companies in the industry are in constant need of ways to improve efficiency and lower costs in production. The challenge is not only in the production of food, but also in its quality, nutrition and energy density, as the current obesity epidemic that is plaguing numerous Western societies, is leading to a rise in numerous diseases, such as type II diabetes, heart disease, and other obesity related ailments.

Therefore, there is a need to better control the composition of foods and restrict caloric content. Currently, the major methods of controlling energy density of food products are based on increasing water and/or air content of the food products. This method is generally applied to emulsion types of foods (e.g. ice cream, mayonnaise, pudding, and others), wherein two immiscible phases, water and fat, are present. The other major method of reducing energy density is through the use of fat mimetics and substitutes. These are used predominately in cases where a small amount of strong sweetener is used to replace large amounts of sugar. Yet, there is a need for a bulk agent to replace the mass of the sugar such that the texture, composition, and general mouth-feel of the food product remain the same.

Fat mimetics tend to be protein or carbohydrate based, that are not absorbed (essentially non-caloric), such as xanthan, pectin, locust bean, and a variety of cellulose products. Fat substitutes are compounds that chemically and physically similar to triglycerides, fats and oils, and can (theoretically) replace fat on a one-to-one basis.

Thus, there is a need to expand and improve existing methods for controlling the nutritional value and energy density of varying food products. The most effective means would be to control the composition of the food product from the bottom-up, controlling the varying qualities on a molecular level. This is feasible using nanoparticles, which allow for a unique degree of compositional control of varying food products [1]. The process of building up food products using nanoparticles would require a malleable and easily available scaffolding material. Further, the scaffolding material would have to be non-immunogenic and little to no absorption in the human body, to ensure that the nutritional value of the food product is only due to the compounds which are pre-selected.

The two materials being considered are cellulose and collagen. Cellulose is a renewable and the most abundant material on the planet. Cellulose in its native state is normally an insoluble high molecular weight polymer. Following acid hydrolysis, it is possible to generate nanocrystalline cellulose (CNC, formerly NCC), lower molecular weight species of cellulose with dimensions 200-300 nm length, 10-20 nm width and of high tensile strength. The CNCs self-assemble and form liquid crystals in solution and have already been used as thickening agents [2]. Collagen is a component in the extra-cellular matrix of varying organisms, however, with recent advances it has been feasibly produced within tobacco plants [3]. Further the use of collagen (also called gelatin, in its denatured state), has been used in varying food products, from “gummy” based sweets to casings for meat products such as sausages, fish fillets, roast beef, and meat pastes [4].

### REFERENCES

[1] Som, C., Berges, M., Chaudhry, Q., Dusinska, M., Fernandes, T. F., Olsen, S. I., and Nowack, B. (2010). The importance of life cycle concepts for the development of safe nanoproducts. Toxicology 269, 160-169.
[2] Lapidot, S., Meirovitch, S., Sharon, S., Heyman, A., Kaplan, D. L., and Shoseyov, O. (2012). Clues for biomimetics from natural composite materials. Nanomedicine (Lond). 7, 1409-1423.
[3] Shoseyov, O., Posen, Y., and Grynspan, F. (2013). Human recombinant type I collagen produced in plants. Tissue Eng. Part A 19, 1527-1533.
[4] Liu, D., Nikoo, M., Boran, G., Zhou, P., and Regenstein, J. M. (2015). Collagen and Gelatin. Annu. Rev. Food Sci. Technol, 6, 527-557.

### GENERAL DESCRIPTION

Three-dimensional (3D) printing is a fabrication process of three-dimensional objects from a digital model. To date, the main activities in 3D printing were focused on the development of materials and printers, which are mainly made of plastics, ceramics and metal. Herein, the inventors propose use of 3D printing for the industrial manufacture of edible products (food).

The vast majority of the printing technologies use the following three approaches:

(A) polymerization of photo-sensitive monomers/oligomers by UV radiation. This technology is based on polymerization and forming of the 3D object by building the structure in a layer-by-layer fashion.

(B) Selective sintering or binding of particles in powder. This technology is based on sintering of a material present in its powder form, achievable by direct sintering, by selective laser sintering (SLS), or by printing a binding liquid.

(C) Direct writing of filaments. This technology is based on deposition of viscoelastic polymers. It requires liquid-like behavior of the ink during the extrusion and solid-like behavior after the deposition to hold the 3D shape.

3D printing of foods currently utilize direct writing of traditionally edible viscoelastic materials (ink), such as starch, chocolate etc.

Herein, the inventors of the technology propose a raw material in the form of nano-crystalline cellulose (CNC, or NCC) and collagen that are specially designed for a 3D printing process. Additionally, the invention provides, a conventional curing approach that uses UV polymerization to stabilize a printed 3D object, the use of a powerful local heating source (such as a CO₂ laser). Both the UV and heating modules interact with the extruded raw material (used as a printing ink), in the vicinity of a printing nozzle, controlling physical and chemical properties of the deposited material. Combination of a 3D architecture with a heterogeneous texture and flavor provides mouth-feel of traditional food products, where the nutritional value may be tailored to the individual.

Thus, the present invention provides a “Food Assembler” and food components (composition) for bottom-up manufacturing of food products. Using edible non-caloric biopolymers, as scaffolds for the nutritional sources, such as a scaffold composed of nanoparticles based on CNC (i.e. texture building block) and a nutritional source, such as, for example, collagen as a protein source, permits controlling not only the total nutritional aspects of different food products, but also the texture, flavor and final aesthetic design of the product.

Thus, by a first aspect the present invention concerns a process for production of a nutritional low-caloric food product, the method comprising formulating each of at least one nutritional material and at least one edible non-caloric material and depositing said formulation(s) into a desired form, by 3-dimentional printing (3D printing), to form a food product of a predetermined nutritional and caloric content.

In another aspect, the invention concerns a process for production of a food product, the method comprising deposition into a desired form, by 3-dimentional printing (3D printing), a combination of at least one nutritional material and at least one edible non-caloric material, and causing said combination to form into a food product.

In some embodiments, the process comprises forming a combination of at least one nutritional material and at least one edible, non-caloric material, in a form suitable for 3D printing.

In some embodiments, the process comprises:
1) providing, in a printable form, at least one nutritional material and at least one edible, non-caloric material;
2) deposition of the at least one nutritional material and at least one edible, non- caloric material by 3D printing; and
3) exposing the deposited material combination under conditions causing said combination to form into a food product.

The “nutritional material” is at least one food material or food component selected from a protein source, a carbohydrate source, a fat source (i.e., a calorie comprising material used for human consumption) and any mixture thereof.

In some embodiments, the at least one nutritional material is two or more such materials, each may independently be selected from a protein source, a carbohydrate source, a fat source, and any other material typically added to a food product. In some embodiments, the at least one nutritional material is selected from a protein source or a carbohydrate source or a fat source, and may comprise two or more from each such food material(s). Thus, when one type of a food material (such as a protein source) is used, a blend of several different of the same food material (e.g., several proteins) may be used.

The nutritional material may be used together with one or more additives commonly used in the food industry, the additives may be selected from a polyol, an amino acid or salt thereof, a poly-amino acid or salt thereof, a sugar acid or salt thereof, a nucleotide, an organic acid, an inorganic acid, an organic salt, an organic acid salt, an organic base salt, an inorganic salt, a bitter compound, a flavorant, a flavoring ingredient, an astringent compound, a surfactant, an emulsifier, a flavonoids, an alcohol, a vitamin, a mineral, a micro-nutrient, a polymer and water.

In some embodiments, the at least one nutritional material is a protein.

The protein source may be a protein or a material comprising a protein. In some embodiments, the protein is selected from collagen, plant base proteins, egg proteins such as albumins, and mucoproteins, and others.

In some embodiments, the at least one nutritional material is a carbohydrate. The carbohydrate may be any carbohydrate or any material comprising a carbohydrate. In some embodiments, the carbohydrate is selected from fructose, lactose, lactulose, maltose, maltulose, sucrose, trehalose, galactose, glucose, arabinose, arabitol, allose, altrose, galactosamine hydrochloride, acetylgalactosamine, hamamelose, lyxose, levo-glucosenone, mannose, mannitol, mannosamine hydrochloride, acetylmannosamine, threose, talose, xylose, galactose, cellulose, CNC, NFC and others.

In some embodiments, the at least one carbohydrate is NCN and/or NFC.

In some embodiments, the at least one nutritional material is fat. The fat component may be selected from saturated fats, unsaturated fats, triglycerides and others. In some embodiments, the fat component is a vegetable fat and/or an animal fat. In some embodiments, the fat is selected from butyric acid, lauric acid, myristic acid, palmitic acid, stearic acid, oleic acid, olive oil and vegetable oils.

In some embodiments, the fat is milk fat.

In other embodiments, the fat is olive oil.

In some embodiments, the nutritional material is a protein, e.g., collagen.

The “edible non-caloric material” is a material previously approved for human consumption, that has zero food calories or less than 5 food calories (thereby being non-caloric) or is substantially low on food calories, namely having less than 40 food calories (per Reference Amounts Customarily Consumed, RACC, which is about 50 grams of the food and per labeled serving). The edible non-caloric material is further selected to be suspended in a liquid carrier and that can upon deposition, and optionally additional chemical reaction (such as cross linking, self assembly trapping, etc), or upon exposure to radiation, such as infrared (IR) radiation or ultraviolet (UV) radiation, form a scaffold suitable for endowing the food product with a desired consistency when consumed.

The edible non-caloric material is a cellulose nano-material selected amongst crystalline nano cellulose (CNC), nano fibrillated cellulose (NFC), chemically modified CNC and chemically modified NFC.

In some embodiments, the edible non-caloric material is CNC or chemically modified CNC.

As known in the art, CNC are elongated crystalline rod-like nanoparticles and the NFC are elongated strings consisting of alternating crystalline and amorphous segments. In some embodiments, the cellulose nano-material is characterized by having at least 50% crystalinity. In some embodiments, the cellulose nano-material is characterized by having at least 55% crystalinity In some embodiments, the cellulose nano-material is characterized by having at least 60% crystalinity In some embodiments, the cellulose nano-material is characterized by having at least 65% crystalinity. In some embodiments, the cellulose nano-material is characterized by having at least 70% crystalinity. In some embodiments, the cellulose nano-material is characterized by having at least 75% crystalinity. In some embodiments, the cellulose nano-material is characterized by having at least 80% crystalinity In some embodiments, the cellulose nano-material is characterized by having at least 85% crystalinity In some embodiments, the cellulose nano-material is characterized by having at least 90% crystalinity. In some embodiments, the cellulose nano-material is characterized by having at least 95% crystalinity

In further embodiments, the cellulose nano-material is monocrystalline. In some embodiments, the cellulose nano-material, produced as particles (e.g., fibrils, or in other cases as crystalline material) from cellulose of various origins, is selected to be at least about 100 nm in length. In other embodiments, they are at most about 1,000 nm in length. In other embodiments, the nanoparticles are between about 100 nm and 1,000 nm in length, between about 100 nm and 900 nm in length, between about 100 nm and 600 nm in length, between about 100 nm and 500 nm in length, between about 100 nm and 400 nm in length, between about 100 nm and 300 nm in length, between about 100 nm and 500 nm in length, between about 100 nm and 200 nm in length, between about 200 nm and 1,000 nm in length, between about 300 nm and 1,000 nm in length, between about 400 nm and 1,000 nm in length, between about 500 nm and 1,000 nm in length, between about 600 nm and 1,000 nm in length, between about 700 nm and 1,000 nm in length, between about 800 nm and 1,000 nm in length, or between about 900 nm and 1,000 nm in length.

In some embodiments, the nanoparticles are about 100, 150, 200, 250, 300, 350, 400, 450, 500, 550, 600, 650, 700, 750, 800, 850, 900, 950 or 1,000 nm in length.

The chemically modified CNC and NFC can be provided by modifying the original CNC or NFC by methacrylation (for example with methacrylic anhydride, acrylic acid, glycidyl methacrylate (GMA) with triethylamine or sodium hydroxide); thiolation (for example by 1-ethyl-3(3-dimethyl aminopropyl/N-hydroxysuccinimide NHS/EDC-catalyzed coupling of NaClO₂-oxidized CNCs with 6-amino-1-hexanethiol, (6-AHT, NH₂—(CH₂)₆—SH) in, e.g., water), esterification (for example with an alkyl ketene dimer (AKD)), or by forming a three dimensional polyester network (for example by castor oil-based polyol (COPO) with diisocyanate as a linker).

Thus, modified CNC or NFC may be selected from esterified CNC or NFC, polymerized CNC or NFC, thiolated CNC or NFC, cross-linked CNC or NFC and other chemically modified CNC or NFC.

The cellulose nano materials may be manufactured as detailed, for example in US2013/171439 and US2013/131332, herein incorporated by reference.

In some embodiments, the food product of the invention comprises CNC and/or NFC and at least one nutritional material.

In some embodiments, the food product of the invention comprises CNC and/or NFC and at least one protein, at least one carbohydrate or at least one fat.

In some embodiments, the food product of the invention comprises CNC and/or NFC and at least one protein, at least one carbohydrate and at least one fat.

In some embodiments, the food product of the invention comprises CNC and/or NFC and at least one nutritional material selected from at least one protein, at least one carbohydrate and at least one fat.

In order to achieve a food product with a desired mouthfeel, the relative amounts of the ingredients in the printed composition may be controlled and varied. The amount (concentration) of the at least one nutritional material and/or the amount of the at least one edible non-caloric material is selected independently to achieve a food product of a desired texture and form. In some embodiments, the at least one edible non-caloric material determines the texture of the food product, as defined hereinbelow, and is thus selected, form and amount, to achieve the desired texture. For example, the amount of the at least one edible non-caloric material may be different in fibrous products as compared to food products having a smooth mouthfeel. Similarly, the amount of water in solid products may be different from gel products.

In some embodiments, the amount of the at least one edible non-caloric material, e.g., CNC, is selected to attribute the food product with a predefined texture, constitution and form. In some embodiments, the at least one edible non-caloric material, e.g., CNC, may be present in the composition and subsequently in the printed product in an amount between 0.1 and 99% (w/w of dry material). In some embodiments, the amount of the at least one edible non-caloric material, e.g., CNC, may be between 1% and 99%, or between 2% and 99%. In some embodiments, the amount of the at least one edible non-caloric material, e.g., CNC, is at least 0.1, 0.5, 1, 2, 3, 4, 5, 6, 7, 8, 9, 10, 11, 12, 13, 14, 15, 16, 17, 18, 19, 20, 21, 22, 23, 24, 25, 26, 27, 28, 29, 30, 31, 32, 33, 34, 35, 36, 37, 38, 39, 40, 41, 42, 43, 44, 45, 46, 47, 48, 49, 50, 51, 52, 53, 54, 55, 56, 57, 58, 59, 60, 61, 62, 63, 64, 65, 66, 67, 68, 69, 70, 71, 72, 73, 74, 75, 76, 77, 78, 79, 80% and at most 99%.

In some embodiments, the amount of the at least one edible non-caloric material, e.g., CNC, may be between 10 and 70% or between 30 and 50% (w/w of dry material).

In some embodiments, the amount of the at least one edible non-caloric material, e.g., CNC, may be between 1 and 99%, between 1 and 95%, between 1 and 90%, between 1 and 85%, between 1 and 80%, between 1 and 75%, between 1 and 70%, between 1 and 65%, between 1 and 60%, between 1 and 55%, between 1 and 50%, between 1 and 45%, between 1 and 40%, between 1 and 35%, between 1 and 30%, between 1 and 25%, between 1 and 20%, between 1 and 15%, between 1 and 10%, between 5 and 99%, between 5 and 95%, between 5 and 90%, between 5 and 85%, between 5 and 80%, between 5 and 75%, between 5 and 70%, between 5 and 65%, between 5 and 60%, between 5 and 55%, between 5 and 50%, between 5 and 45%, between 5 and 40%, between 5 and 35%, between 4 and 30%, between 5 and 25%, between 5 and 20%, between 5 and 15%, between 5 and 10%, between 10 and 99%, between 10 and 95%, between 10 and 90%, between 10 and 85%, between 10 and 80%, between 10 and 75%, between 10 and 70%, between 10 and 65%, between 10 and 60%, between 10 and 55%, between 10 and 50%, between 10 and 45%, between 10 and 40%, between 10 and 35%, between 10 and 30%, between 10 and 25%, between 10 and 20%, between 20 and 99%, between 20 and 95%, between 20 and 90%, between 20 and 85%, between 20 and 80%, between 20 and 75%, between 20 and 70%, between 20 and 65%, between 20 and 60%, between 20 and 55%, between 20 and 50%, between 20 and 45%, between 20 and 40%, between 20 and 35%, between 20 and 30%, between 30 and 99%, between 30 and 95%, between 30 and 90%, between 30 and 85%, between 30 and 80%, between 30 and 75%, between 30 and 70%, between 30 and 65%, between 30 and 60%, between 30 and 55%, between 30 and 50%, between 30 and 45%, between 30 and 40%, between 50 and 99%, between 50 and 95%, between 50 and 90%, between 50 and 85%, between 50 and 80%, between 50 and 75%, between 50 and 70%, between 50 and 65%, between 50 and 60%, between 60 and 99%, between 60 and 95%, between 60 and 90%, between 60 and 85%, between 60 and 80%, between 60 and 75%, between 60 and 70%, between 70 and 99%, between 70 and 95%, between 70 and 90%, between 70 and 85%, between 70 and 80%, between 80 and 99%, between 80 and 95%, between 80 and 90%, between 90 and 99% (w/w of dry material).

In some embodiments, the amount of the at least one edible non-caloric material, e.g., CNC, may be non-homogenously distributed in the food product such that some regions of the product comprise only the at least one edible non-caloric material, e.g., CNC, and are thus 100% or substantially 100% CNC, while other regions may comprise combinations of the of the at least one edible non-caloric material with the at least one nutritional material, or any other material present such that the amount of the at least one edible non-caloric material, e.g., CNC is below 100%.

The amount of the at least one nutritional material may be similarly adjusted. In some embodiments, the amount of the at least one nutritional material is selected to attribute the food product with a predefined texture, constitution and form. In some embodiments, the amount of the at least one nutritional material is between 1 and 85%, or between 10 and 70%, or between 20 and 60%, or between 30 and 50% or between 40 and 85% (w/w of dry material).

In some embodiments, the amount of the at least one nutritional material is between 1 and 85%, between 1 and 80%, between 1 and 75%, between 1 and 70%, between 1 and 65%, between 1 and 60%, between 1 and 55%, between 1 and 50%, between 1 and 45%, between 1 and 40%, between 1 and 35%, between 1 and 30%, between 1 and 25%, between 1 and 20%, between 1 and 15%, between 1 and 10%, between 1 and 5%, between 5 and 85%, between 5 and 80%, between 5 and 75%, between 5 and 70%, between 5 and 65%, between 5 and 60%, between 5 and 55%, between 5 and 50%, between 5 and 45%, between 5 and 40%, between 5 and 35%, between 4 and 30%, between 5 and 25%, between 5 and 20%, between 5 and 15%, between 5 and 10%, between 10 and 99%, between 10 and 85%, between 10 and 80%, between 10 and 75%, between 10 and 70%, between 10 and 65%, between 10 and 60%, between 10 and 55%, between 10 and 50%, between 10 and 45%, between 10 and 40%, between 10 and 35%, between 10 and 30%, between 10 and 25%, between 10 and 20%, between 20 and 85%, between 20 and 80%, between 20 and 75%, between 20 and 70%, between 20 and 65%, between 20 and 60%, between 20 and 55%, between 20 and 50%, between 20 and 45%, between 20 and 40%, between 20 and 35%, between 20 and 30%, between 30 and 85%, between 30 and 80%, between 30 and 75%, between 30 and 70%, between 30 and 65%, between 30 and 60%, between 30 and 55%, between 30 and 50%, between 30 and 45%, between 30 and 40%, between 50 and 85%, between 50 and 80%, between 50 and 75%, between 50 and 70%, between 50 and 65%, between 50 and 60%, between 60 and 85%, between 60 and 80%, between 60 and 75%, between 60 and 70%, between 70 and 85%, between 70 and 80% or between 80 and 85% (w/w of dry material).

In some embodiments, the amount of the at least one edible non-caloric material, e.g., CNC, and the amount of the at least one nutritional material are independently or in relation to each other selected to attribute the food product with a predefined texture, constitution and form. In some embodiments, the ratio between the at least one nutritional material and at least one edible non-caloric material is between 0.1:100, 0.5: 100, 1:100, 10:100, 20:100, 30:100, 40:100, 1:2, 1:1, 2:1, 100:40, 100:30, 100:20, 100:10, 100:0.1, respectively.

The combinations of the at least one nutritional material and at least one edible non-caloric material are provided in printable forms, namely in a form which permits their facile and efficient deposition in accordance with the invention. The printable form may depend on the process by which deposition is carried out for constructing the food product 3D shape. In some embodiments, the printable form is a formulation, a dispersion or a suspension of the components of the combination in a liquid media. Thus, the combination of the at least one nutritional material and at least one edible non-caloric material is provided as a formulation, suspension or emulsion or a mixture thereof in a liquid carrier that enables deposition of the combination and subsequent reactivity under thermal or irradiation treatment(s). The liquid carrier or solvent may be selected from alcoholic solvents and aqueous media. In some embodiments, the liquid carrier is water or a water-containing liquid carrier, such as water/ethanol. In some embodiments, the carrier is ethanol and/or water. In some embodiments, the carrier is an oil-water emulsion; the oil being selected from glycerin, propylene glycol, food-grade oils, fruit oils, vegetable oils and others.

In some embodiments, each of the components making up a combination for use in accordance with the invention is formulated in a liquid carrier, separately and independently from the other component. For example, the CNC and/or NFC or the chemically modified derivatives thereof can be provided in one container for printing, and the nutritional material can be provided in another container for printing, each may be present in the same or in a different liquid carrier.

In some embodiments, the carrier may further include surfactants, food-grade nonionic hydrophilic emulsifiers, co-solvent, alcohols, polyols, food-grade photo-initiators, enzymes, stabilizers, coloring agents, flavoring agents, and others.

In some embodiments, the carrier may comprise at least one enzyme.

The deposition of a formulation, suspension, emulsion or mixture of the combination with a liquid carrier onto a surface so as to begin construction of a 3D food product and each of the subsequent deposition steps may be carried out by any deposition method known in the art which involves the so-called 3D printing methodology.

The deposition process may include one or more process steps utilizing a 3D printer, as available in the art. The printer may be used to deposit each of the components from a separate container or from one or more containers which comprise each of the components or mixtures thereof. In some embodiments, the construction of the food product is achievable by a printer similar to and technologically adaptable from an ink-jet printer, wherein the printing “ink” is a food composition comprising one or more of at least one nutritional material, at least one edible non-caloric material and any of the additives mentioned herein. Thus, the invention further provides a composition or formulation for forming a food product by 3D printing (or 3D deposition process), the composition or formulation comprising at least one edible non-caloric material.

The invention further provides a composition or a formulation for forming a food product by 3D printing (or 3D deposition process), the composition or formulation comprising at least one of a nutritional material and an edible non-caloric material with at least one additive.

In some embodiments, the composition or formulation for forming a food product by 3D printing comprises CNC.

In accordance with a process of the invention, the composition or formulation is deposited layer by layer, bottom-up, wherein each deposited layer is thermally treated individually, after its deposition, or wherein thermal treatment is affected after each drop is deposited or after the full object is formed.

In some embodiments, thermal treatment is alternatively or additionally directed at each drop of a combination of the least one nutritional material and at least one edible, non-caloric material, which are deposited. Thus, the process may comprise multiple steps of thermal treatment, under a controlled heat source(s) to permit conversion of the deposited combination into a food product.

In some embodiments, heating of a deposited combination, drop-wise, and/or after formation of each of the deposited layer, allows forming a material scaffold. Optionally the process further comprises exposition of the deposited material to additional chemical/enzymatic reactions, or to an additional irradiation source, e.g., heat, UV.

In an exemplary process of the invention, a combination of at least one nutritional material and at least one edible, non-caloric material is extruded from a printing or deposition nozzle at a temperature being typically lower than 100° C. The selected temperature may vary depending on the specific selection of materials and the food product to be produced. After being deposited (either as a first layer on a surface or as a further layer on top of a previously deposited layer in a second or subsequent step) the liquid carrier in which the materials may be carried is exposed to the heat source immediately after it is deposited. The power of the heat source can be rapidly regulated and controlled, thereby subjecting the deposited material to varying but controlled local heating power.

The varying and controlled heating may have one or more of the following in the manufacture of a food product:
first, varying the local heating can evaporate varying but controlled amounts of the liquid carrier, thus locally changing the consistency of the deposited material from that of a soft gel (with high amounts of liquid) to that of a firm solid with little or no liquid, changing in various regions the consistency of the food product. Typically this may modify the water content to be between 0 and 98%.
second, varying the temperature can cause IR curing of the non-caloric component (e.g., CNC) through self-assembly of the material, e.g., via hydrogen bonds, electrostatic interactions or van der Waals interactions or formation of ester bonds. Thus, localized changing/control of water content by focused IR heating results in non-uniform/heterogeneous consistency.
third, varying the temperature can cause Maillard reaction. As known in the art, the Maillard reaction is a chemical reaction between amino acids and reducing sugars that gives browned foods their desirable flavor. The reaction is a form of browning which typically proceeds rapidly from around 140 to 165° C. At higher temperatures, caramelization and subsequently pyrolysis become more pronounced. Each type of food has a very distinctive set of flavor compounds that are formed during the Maillard reaction, giving desired regions of the food product a roast flavor.

Each of the effects of the varying controlled temperature may be carried out separately in different regions of the food product, giving the food product a desired consistency and flavor.

Food texture is a primary attribute that together with the visual appearance, taste and aroma of the food product defines its quality and marketability. As the process of the present invention provides the ability to tailor food products, which not only resemble foods commonly available to the public, that are of low caloric value, yet nutritional, but also control the water content and the mouthfeel of the product, food products of a great variety of textures may be manufactured. Food products of the invention may be attributed with any one texture or consistency known in the field, including: solid, gels, semi-solids, fluidic solids or gels, granulated products, fibrous, and others. When solids are concerned, the solid product may be formed to have a crunchy or crispy texture and feeling, may be resistant to deformation, resistant to cutting, resistant to mastication, and/or exhibit a certain defined in-mouth movement. Similarly, the products may be in the form of gels of various consistencies and viscosities. Thus, any food product according to the invention may be formed, manufactured or prepared with a predefined cohesiveness, hardness, roughness, heaviness, density, dryness, moisture absorption and moisture release, crispiness, crunchiness, fracturability, softness, springiness, stickiness, gumminess, mouth-coating, tackiness, graininess, uniformity, viscosity, wetness (water content and distribution of water in the product) and with any other property of foods.

The ability to achieve a food product with a certain texture or attributes as defined herein, depends not only on the material constituents, such as the CNC, but also on the water content and the ability to control, by drying, the product water content or dryness. The thermal treatment needed, in some embodiments, to induce a chemical reaction in the food composition, is also utilized for evaporating some of the liquid media present in the product. The selection of an appropriate temperature may depend on the desired effects or attributes, as discussed herein. For example, where evaporation is desired the temperature range may be between 25 and 140° C. or between 25 and 120° C. or between 25 and 100° C. Where a Maillard reaction is desired, the temperature may be set to between 140 and 185° C. or between 140 and 175° C. or between 140 and 165° C.

Thus, in some embodiments, thermal treatment is carried out at a temperature selected to (a) cause evaporation of at least an amount of the liquid carrier, to thereby affect the consistency of the deposited material; and/or (b) cause curing of the non-caloric component; and/or (c) affect interaction between amino acids and reducing sugars present in the deposited material.

The thermal treatment may be carried out by exposing the deposited combination to a heat source or to any irradiation source that can increase the temperature of the deposited material at a time range fast enough for printing, e.g., at least 10 μl per second to several seconds. An example of such a heat source is a CO₂ laser, or any other laser that is strongly absorbed by water, such as Er:YAG laser, emitting light with a wavelength of 2940 nm.

In some embodiments, the composition for printing comprises CNC and/or NFC which are methacrylated and at least one food-grade photo-initiator and the process comprises depositing the composition and thereafter or concurrently with said deposition irradiating with a UV radiation source at a wavelength of 365 nm, with an intensity and for a duration of time sufficient to cause cross-linking of the methacrylated material.

In some other embodiments, the nutritional material is cross-linked by an enzymatic reaction suitable for a selected material. Where the nutritional material is at least one protein, the cross-linking may be achieved by transglutaminases (TGases) enzymes. Where the nutritional material is a carbohydrate, cross-linking may be achieved by use of a transglycosidase enzymes and where the nutritional material is fat, cross-linking may be achieved by use of a lipase/esterase enzymes.

Where cross-linking of a nutritional material is desired, the enzymes utilized for this purpose may be stored and separately deposited to avoid undesired crosslinking prior to deposition. Thus, the enzymes may be separately stored from the nutritional materials and come into contact therewith only during or while being deposited. Alternatively, the enzymes may be stored in a container containing only the non-caloric material, e.g., the CNC/NFC material, which may be unreactive to the enzymes.

Cross-linking may alternatively or additionally be achieved by oxidation.

In some embodiments, the food product is formed by thermal treatment, which is optionally induced by radio frequency (RF) irradiation, microwave irradiation, infrared (IR) irradiation or ultraviolet (UV) irradiation.

In some embodiments, one or both of said at least one nutritional material and at least one edible non-caloric material is deposited in a formulation comprising at least one enzyme, and the process thus further comprising a step of inducing enzymatic cross-linking.

The invention further contemplates use of CNC and/or NFC in the manufacture of a food product, wherein the amount of the CNC and/or the NFC in said product is as defined herein. In some embodiments, the manufacture is by 3D printing.

The invention further contemplates a CNC and/or NFC matrix infused with at least one nutritional material, as defined, and optionally one or more edible additives.

The invention further contemplates a food product comprising a CNC.

The invention further provides in another of its aspects, an edible food product produced by 3D deposition. The edible food product, as manufactured by a process of the invention, is a product which may be consumed by a human subject or an animal and which provides the consumer with a desired nutritional value, yet with limited, controlled caloric content.

The invention further provides a food product comprising a CNC, the product manufactured by 3D printing.

As used herein, a food product according to the invention, or produced according to a process of the invention, comprises at least one “nutritional material” and at least one “edible non-caloric material”, as defined herein. In some embodiments, the food product is an isolated food material, a self-assembled CNC product, a cross-linked modified CNC product, a food product comprising cross-linked protein and CNC (wherein the CNC may be assembled or non-assembled), or a product produced in the form of a CNC matrix infused with at least one nutritional edible material.

In some embodiments, the food product, in accordance with the invention, is any food product known in the art, identifiable based, inter alia, on the nutritional material used, flavors and consistency of the CNC matrix. The food product may be selected from hamburgers, nuggets, pizza, cake, pasta, sweets, candy, etc.

In some embodiments, the food product is constructed of an edible non-caloric material, such as a CNC matrix, manufactured by 3D printing or by any other means, which is subsequently infused with the at least one nutritional material. The manufacture of such a product renders unnecessary to pre-mix the at least one nutritional material and at least one edible non-caloric material prior to 3D printing. In such embodiments, the nutritional material may be a mixture of fresh extracts from any food source, or any of the above-mentioned materials, which may be freshly infused into the edible non-caloric materail. The consistency and heterogeneity (or homogeneity) of a particular product or portion thereof can thus be controlled and modified by modulating, inter alia, the material, e.g., CNC, the material concentration, the material distribution in the product, the wall thickness, compartment or cavity or pore size, and treatment conditions, e.g., temperature.

The invention further contemplates a system in the form of a food assembler for the manufacture or assembly of a food product according to the invention. The food assembler generally comprises an extrusion system for extruding a composition according to the invention (e.g., comprising one or more of at least one nutritional material and/or at least one edible non-caloric material and/or any other component of the food composition as disclosed herein, alone or in combination); and a heating source assembled to permit focused (direct) thermal radiation onto an extruded sample.

In some embodiments, the extruder is a nozzle assembly of, e.g., an ink-jet printing apparatus. In some embodiments, the assembly operates in direct ink writing mode; namely, the nozzle moves relatively to a deposition tray onto which the composition is extruded. In some embodiments, the extruded composition hardens immediately after deposition.

In some embodiments, the composition comprises one or more ingredients that may be premixed or deposited sequentially. In such cases where the ingredients are premixed, premixing may be achieved off-site or before loading of the composition into the assembler or may be premixed in separate modules and then extruded from a nozzle. In some embodiments, premixing may be executed in the nozzle. In such a case, the nozzle assembly may comprise, for example multiple inlets, a mixing channel, and one or more outlets.

The composition may be extruded on a surface of a moving deposition tray positioned in the assembler to operatively move in all possible directions in relation to the nozzle assembly. During extrusion of an amount of the composition, the nozzle assembly or the deposition tray may be moved in all directions by a motorized system. The premixed composition may be extruded from the nozzle outlet in one of the following modes:
a) a continuous extrusion mode (line by line) with control of the deposited line volume.
b) a dripping mode (drop by drop) with control of the deposited drop volume.
c) a combination mode in which a continuous mode and a dripping mode are involved.

In some embodiments, the nozzle assembly or any one nozzle is associated with one or more outlet to allow sequential deposition of different compositions.

All additional modules for the local post treatment of the ink are part of the extrusion system. These modules are aligned relatively to the extrusion nozzle. In case of a moving nozzle, all modules move with it. Modules can rotate in the x-y plane around the nozzle according to the direction of the nozzle or the tray.

The heating source may be a heating assembly comprising or consisting a UV module selected to facilitate continuous curing of compositions comprising photo-sensitive materials.

Alternatively or additionally, the heating source may be a heating assembly comprising or consisting an IR module for local heating of the composition to thereby facilitate, e.g., enhanced evaporation of water content. In some embodiments, the IR module comprises a CO₂ laser or an IR sources such as Er:YAG laser.

Additionally, the heating source may be a heating assembly comprising a dry and hot air-jet.

In some embodiments, heating is achievable by radio frequency (RF) irradiation, microwave irradiation, infrared (IR) irradiation or ultraviolet (UV) irradiation.

In further embodiments, the assembler is computer controlled. The architecture of the printed food product is pre-designed in a 3D drawing software.

The invention further provides a system comprising an extrusion system for extruding at least one material; and a heating source assembled to permit focused (direct) radiation onto an extruded sample, wherein the radiation is IR.

In some embodiments, the extrusion system is an ink-jet system.

In some embodiments, the system comprises an IR module, the module optionally comprising a CO₂ laser or an IR sources such as Er:YAG laser.

### BRIEF DESCRIPTION OF THE DRAWINGS

In order to better understand the subject matter that is disclosed herein and to exemplify how it may be carried out in practice, embodiments will now be described, by way of non-limiting example only, with reference to the accompanying drawings, in which:

FIG. 1 is a schematic drawing of a 3D food assembler in the form of a computer operated 3D deposition system for the manufacture of edible products according to the invention.

### DETAILED DESCRIPTION OF EMBODIMENTS

A none-limiting example is provided in the form of a prototype food assembler, capable of generating edible food products according to the invention, e.g., products which are similar to meat products in texture and flavor, yet having low energy density, based on a CNC and collagen scaffolding. The assembly may utilize varying concentrations of CNC and Collagen at any CNC/NFC to collagen ratio. Also, self-assembling and cross-linking of the CNC-collagen composite can be achieved by using various techniques, e.g., laser beam heating, as well as by using food industry standard enzymes such as transglutaminases (TGases).

As most food products are not uniform in structure or shape, an observation which influences the visual aesthetic and mouthfeel, the ability to engineer and control these factors is crucial. Generally, a deposition of 50-μm amounts of a composition according to the invention is achieved by 3D printing, so that each deposition (i.e. extrusion from the 3D printer/blotter) can be controlled to vary or be the same as a previous deposited amount; thereby controlling the properties of each blot, such that the printed food is non-uniform.

In an exemplary system, CNC-Collagen composite having meat-like qualities utilize a CNC concentration in the range of 1-10% (w/w), and collagen concentration in the range of 0.3-4% (w/v). Such a composition was extruded and heated to induce Maillard reaction and cross-linking In some embodiments, the composition also utilized a transglutaminase to achieve cross-linking.

### Determination of Physical and Chemical Properties of CNC-Collagen Composite

Dynamic Mechanical Analysis (DMA) is used to test the thermomechanical properties of the cross-linking of the composite for calculating the Dynamic Storage modulus, Loss Modulus, glass transition temperature, and robustness of the cross-linking.

Instron Testing: Determining the tensile strength of the crosslinks in the composite. Using an Instron 3345 tester (100 N load cell, 1 mm/min crosshead speed), tensile strength, elongation at break, and Young's modulus is tested.

FTIR Analysis: Using an FTIR 5700 spectrometer, at 4000-700 cm⁻¹, the structures of the crosslinks between the CNC-collagen are determined.

Differential Scanning Calorimetry (DSC): The thermodynamics of the composite is determined. The glass transition, crystallization temperature, and melting temperature is determined from these measurements.

Head-space GC-MS is utilized to determine volatiles produced by Maillard reaction.

### Determination of Morphological Properties of CNC-Collagen Composite

Scanning Electron Microscope (SEM) is used to observe the surface of the CNC-Collagen composite using an S-4800 SEM (10 kV accelerating voltage).

Three dimensional Deposition of CNC-Collagen Composite

Using a three dimensional blotter, a translational stage and extruding nozzle loaded with CNC-Collagen is used to control the creation of the new food product.

### Detailed Description of a Food Assembler According to the Invention

Direct Ink Writing

The motorized part of an assembly according to the invention operates in mode of direct ink writing. Namely, the nozzle moves in a 3D space relatively to a deposition tray and extrudes the ink that hardens immediately after deposition. The ink may consist of multiple ingredients that can be premixed or deposited sequentially. The architecture of the printed object previously designed in a 3D drawing software. The complete system is controlled by a computer. Deposition rate, pattern, content, post-treatment procedures can change during the printing of a product to provide optimal mimicking of a desired food product.

Premixing

The composition as a raw material (ink) may contain multiple ingredients, which may be premixed in separate modules and then extruded from a nozzle. The premixing may be executed in the nozzle. In such a case, the nozzle has multiple inlets, a mixing channel, and one or more outlets.

Extrusion Process Options

During the extrusion the nozzle or the deposition tray may be moved in all directions by a motorized system controlled by a computer software. The premixed ink may be extruded from the nozzle outlet in one of the following modes:
d) A continuous extrusion mode (line by line) with control of the deposited line volume.
e) A dripping mode (drop by drop) with control of the deposited drop volume.
f) A combination mode in which a continuous mode and a dripping mode are involved.

The nozzle can have one or more outlets to allow sequential deposition of different types of ink in one of the modes.

Post Treatment of the Deposited Ink

All additional modules for the local post treatment of the ink are part of the extrusion system. These modules aligned relatively to the extrusion nozzle. In case of the moving nozzle, all modules move with it. Modules can rotate in the x-y plane around the nozzle according to nozzle or tray movement direction. All modules operated from computer and synchronized with the extrusion module and moving motors.

A UV module facilitates continuous curing of the photo-sensitive inks. Any UV source with sufficient power can be used (e.g. diode, laser, discharge lamp). The illumination can be delivered through an open space (lens system) or optical fiber. The end terminal has focusing lens to provide spot illumination. Focusing lens aligned to the nozzle. The illumination time can be controlled directly by changing the illumination power or by faster deposition rate that results in shorter exposure to UV.

An IR module for local heating of the liquid ink facilitates enhanced evaporation of the water content and can encourage chemical reaction in other ink substances (e.g. Maillard reaction). CO₂ laser and other powerful IR sources (e.g. Er:YAG laser), which are well absorbed in water, can be delivered through an open space (lens system) or optical fiber. The end terminal has focusing lens to provide spot illumination. Focusing lens aligned to the nozzle. The illumination time can be controlled directly by changing the illumination power, typically by pulse width modulation (PWM), or by faster deposition rate that results in shorter exposure to IR.

Additionally to IR heating, dry and hot air-jet can be locally applied to increase the evaporation rate of the water content. Hot air can be supplied by the air cooling that is needed to cool the IR focusing lens.

A second IR scanning may be implemented in parallel or sequential to the deposition scanning

A laser beam shaping can be implemented to optimize effective heating.

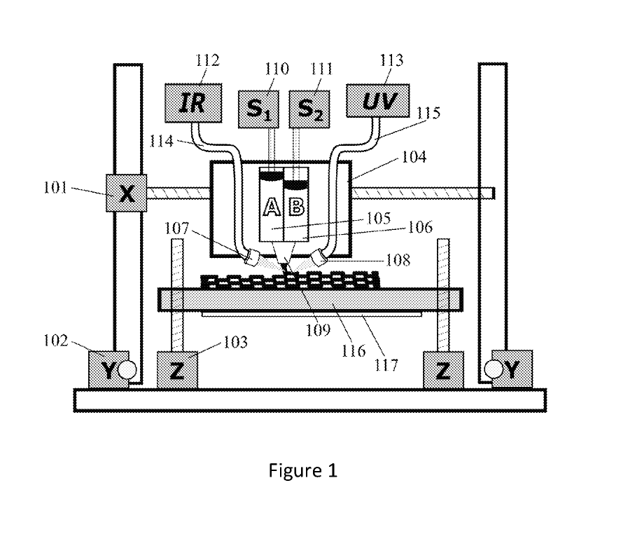

FIG. 1 provides a schematic drawing of the 3D food assembler (i.e. computer operated 3D deposition system for edible materials). In the assembler, motors X, Y, Z (101,102,103) enable three dimensional movement of an extrusion system (104). The extrusion system includes two separated containers labeled A (105) and B (106) that contain, separately, a viscous solution of CNC and collagen or a combination of the two and a focusing piece/objective/lens (107, 108) for IR and UV irradiation, respectively or alternatively. The content of the container(s) A and/or B is extruded through the mixing nozzle (109) by computer operated pistons S1 and S2 (110 and 111) in parallel or one by one. After being extruded the material can be irradiated by a focused IR light and/or a UV light source (112, 113) delivered by optical fibers or a mirror assembly (114, 115). The IR and/or UV focusing piece/objective/lens (107, 108) is fixed to the extrusion stage and moves together with the extrusion nozzle. The assembly may alternatively be rotated in the x-y plane around the nozzle. The whole system is isolated to allow control over humidity and temperature inside the assembler. The deposition tray (116) may be heated or cooled with a thermoelectric device (117).

1.-75. (canceled)

76. A process for producing a food product, the process comprising depositing into a desired form, by 3-dimensional printing (3D printing), at least one nutritional material and crystalline nano cellulose (CNC), and causing said deposited materials to form into a food product.

77. The process according to claim 76, further comprising a step of formulating the at least one nutritional material and CNC, into a form suitable for 3D printing.

78. The process according to claim 76, the process comprising:
1) providing, in a printable form, at least one nutritional material and CNC;
2) depositing the at least one nutritional material and CNC by 3D printing, wherein each material is deposited separately or in a pre-formed mixture; and
3) exposing the deposited materials under conditions causing said materials to form into a food product.

79. The process according to claim 76, wherein said at least one nutritional material is deposited together with one or more additives selected from a polyol, an amino acid or salt thereof, a poly-amino acid or salt thereof, a sugar acid or salt thereof, a nucleotide, an organic acid, an inorganic acid, an organic salt, an organic acid salt, an organic base salt, an inorganic salt, a bitter compound, a flavorant, a flavoring ingredient, an astringent compound, a surfactant, an emulsifier, a flavonoids, an alcohol, a vitamin, a mineral, a micro-nutrient and a polymer.

80. The process according to claim 76, wherein the at least one nutritional material is selected from a protein, a carbohydrate and a fat, wherein the protein is optionally collagen.

81. The process according to claim 76, wherein formulating is carried out in a liquid carrier selected from alcoholic solvents and aqueous media, or is water or a water-containing liquid carrier, or is an oil-water emulsion.

82. The process according to claim 76, wherein deposition of the at least one nutritional material and CNC, separately or pre-mixed, is carried out layer by layer, wherein each deposited layer is thermally treated individually, after deposition, or carried out drop-wise, wherein each deposited drop is thermally treated.

83. The process according to claim 76, wherein deposition of the at least one nutritional material and CNC, separately or pre-mixed, is carried out layer by layer, wherein following complete production of the product it is thermally treated.

84. The process according to claim 82, wherein the temperature of the thermal treatment is selected to cause controlled evaporation of the liquid carrier or self-assembly of any of the materials in the deposited drop or layer.

85. The process according to claim 82, wherein the temperature of the thermal treatment is selected to induce Maillard reaction.

86. The process according to claim 76, wherein one or both of said at least one nutritional material and CNC is deposited in a formulation comprising at least one enzyme.

87. The process according to claim 76, wherein the food product is a solid product or a gel.

88. An edible food product comprising CNC, said product produced by 3D printing.

89. A system for manufacturing a food product, the system comprising an extrusion system for extruding a composition comprising at least one nutritional material and/or CNC; and a heating source assembled to permit focused (direct) radiation onto an extruded sample.

90. The system according to claim 89, wherein the extruder is in a form of a nozzle assembly.

91. The system according to claim 90, wherein the assembly operates in a direct ink writing mode.

92. The system according to claim 89, wherein the heating source is a heating assembly comprising a UV module selected to facilitate continuous curing of compositions comprising photo-sensitive materials.

93. The system according to claim 89, wherein the heating source is a heating assembly comprising an IR module for local heating of the composition.

94. The system according to claim 89, wherein the heating source comprises a CO2 laser or Er:YAG laser or wherein the heating is achievable by radio frequency (RF) irradiation, microwave irradiation, infrared (IR) irradiation or ultraviolet (UV) irradiation.

95. A system comprising an extrusion system for extruding at least one material; and a heating source assembled to permit focused (direct) radiation onto an extruded sample, wherein the radiation is IR.

96. The system according to claim 95, wherein the extrusion system is an ink-jet system.

97. The system according to claim 95, the system further comprising an IR module, and optionally comprising an IR source, a CO2 laser or a Er:YAG laser.
